(19) United States
(12) Patent Application Publication
(10) Pub. No.: US 2021/0081359 A1
(43) Pub. Date: Mar. 18, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Toshihiko TANABE, Kanagawa (JP)

(73) Assignee: FUJI XEROX CO., LTD., Tokyo (JP)

(21) Appl. No.: 16/781,496

(22) Filed: Feb. 4, 2020

(30) Foreign Application Priority Data
Sep. 13, 2019 (JP) 2019-166916

(51) Int. Cl. G06F 16/16; G06F 3/12; G06F 16/11

(52) U.S. Cl. CPC G06F 16/166; G06F 3/1222; G06F 16/116; G06F 3/1273

(57) ABSTRACT

An information processing apparatus includes a processor configured to, in a case where a destination of a job is a shared apparatus shared by plural groups and a file name of a file to be processed by the job includes confidential information, transmit the job to the shared apparatus after converting the confidential information into a different character string.

### CROSS-REFERENCE TO RELATED APPLICATIONS

This application is based on and claims priority under 35 USC 119 from Japanese Patent Application No. 2019-166916 filed Sep. 13, 2019.

### BACKGROUND

### (i) Technical Field

The present disclosure relates to an information processing apparatus and a non-transitory computer readable medium.

### (ii) Related Art

In recent years, the number of shared workspaces, which are work spaces shared by plural companies or self-employed people, is increasing. A sharable image forming apparatus is placed in some shared workspaces. In such a shared workspace, a user uses the image forming apparatus by transmitting a print job to the image forming apparatus, for example, from his or her PC and thereby causing the image forming apparatus to execute printing.

Examples of the related art are disclosed in Japanese Unexamined Patent Application Publication Nos. 2008-234441 and 2008-077211.

### SUMMARY

A shared apparatus shared by plural groups executes a received job and generates and stores therein history information as a job execution history. The history information includes a file name of a file processed by execution of the job. If the file name of the file includes confidential information, the confidential information is stored as part of the history information. This arouses security concern. It is therefore desirable to take some sort of measures to prevent leakage of information when transmitting a job to the shared apparatus.

Aspects of non-limiting embodiments of the present disclosure relate to making it possible to prevent leakage of confidential information as compared with a case where a job is transmitted without converting confidential information included in a file name of a file to be processed by the job.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to, in a case where a destination of a job is a shared apparatus shared by plural groups and a file name of a file to be processed by the job includes confidential information, transmit the job to the shared apparatus after converting the confidential information into a different character string.

### BRIEF DESCRIPTION OF THE DRAWINGS

An exemplary embodiment of the present disclosure will be described in detail based on the following figures, wherein:

FIG. 1 illustrates an example of a hardware configuration of an information processing apparatus according to the present exemplary embodiment;

FIG. 2 illustrates an example of a block configuration of the information processing apparatus according to the present exemplary embodiment;

FIG. 3 illustrates an example of an owned printing machine setting screen according to the present exemplary embodiment;

FIG. 4 illustrates an example of a conversion rule information setting screen according to the present exemplary embodiment, specifically, illustrates an example of a screen for setting and registering a file name conversion list included in conversion rule information;

FIG. 5 illustrates an example of a conversion rule information setting screen according to the present exemplary embodiment, specifically, illustrates an example of a screen for setting and registering a conversion range rule included in conversion rule information;

FIG. 6 is a flowchart illustrating print job transmitting processing according to the present exemplary embodiment;

FIG. 7 illustrates an example of a data configuration of correspondence information stored in a correspondence information storage unit according to the present exemplary embodiment;

FIG. 8 illustrates an example of a file name setting screen according to the present exemplary embodiment; and

FIG. 9 illustrates an example of a case where a file name is converted by using a conversion range rule according to the present exemplary embodiment.

### DETAILED DESCRIPTION

An exemplary embodiment of the present disclosure is described below with reference to the drawings.

An information processing apparatus according to the present exemplary embodiment is assumed to be used in an environment (e.g., a shared workspace) shared by plural companies or self-employed people. In such an environment (e.g., on a floor on which a shared workspace is present) in which the information processing apparatus is used, an image forming apparatus is placed. The plural companies or self-employed people are companies etc. belonging to plural different groups that are not obliged to keep each other□s secrets. The image forming apparatus is shared by persons belonging to these companies etc. by using their own information processing apparatuses. For example, a person uses the image forming apparatus by transmitting a print job from his or her information processing apparatus to the image forming apparatus and thereby causing the image forming apparatus to execute printing. Hereinafter, such an image forming apparatus shared by plural groups is referred to as a “shared apparatus”.

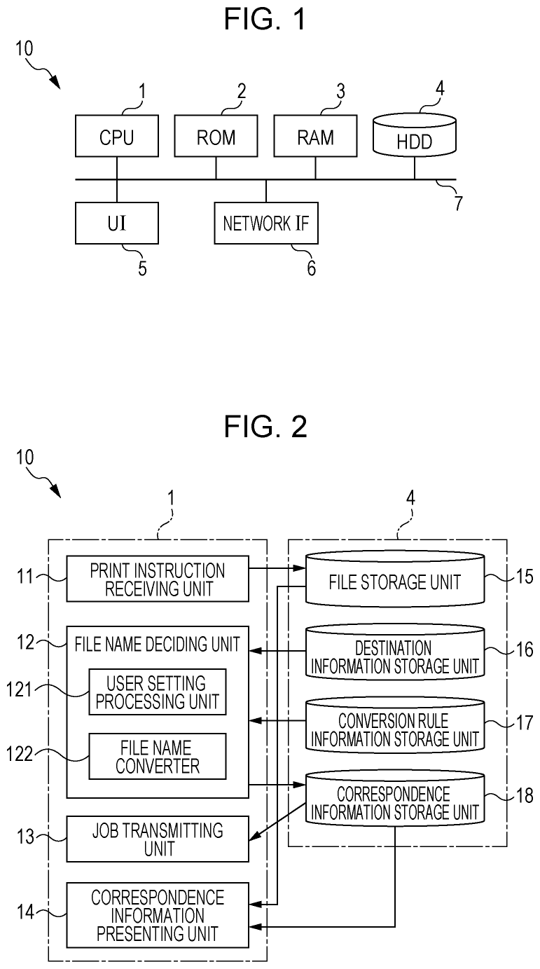

The information processing apparatus according to the present exemplary embodiment can be existing general-purpose hardware such as a personal computer (PC). That is, an information processing apparatus 10 according to the present exemplary embodiment includes a CPU 1, a ROM 2, a RAM 3, a memory such as a hard disk drive (HDD) 4, a user interface (UI) 5, and a communication unit such as a network interface (IF) 6 used, for example, to transmit a job to the shared apparatus as illustrated in FIG. 1. These constituent elements of the information processing apparatus 10 are connected to an internal bus 7. The user interface 5 may have a mouse and a keyboard as input units and a display device as a display. Alternatively, the user interface 5 may be, for example, a touch panel type liquid crystal panel that serves as both of an input unit and a display.

FIG. 2 illustrates an example of a block configuration of the information processing apparatus according to the present exemplary embodiment. The information processing apparatus 10 according to the present exemplary embodiment includes a print instruction receiving unit 11, a file name deciding unit 12, a job transmitting unit 13, a correspondence information presenting unit 14, a file storage unit 15, a destination information storage unit 16, a conversion rule information storage unit 17, and a correspondence information storage unit 18. Note that constituent elements that are not used for description of the present exemplary embodiment are omitted from FIG. 2. The print instruction receiving unit 11 receives a print instruction from a user. The file name deciding unit 12 decides a file name of a file to be processed by a print job. A user setting processing unit 121 included in the file name deciding unit 12 executes processing for causing a user to set a file name of a file to be processed. A “user” in the present exemplary embodiment refers to an employee belonging to any of the companies or a self-employed person. In particular, a user who sets a file name is a user who requests execution of a job, i.e., a sender of a job (hereinafter referred to as a “job sender”). In a case where a file name of a file to be processed by a print job includes confidential information, a file name converter 122 included in the file name deciding unit 12 changes the file name of the file by automatically converting the confidential information into a different character string. The job transmitting unit 13 transmits a print job to a designated destination, examples of which include an image forming apparatus. When a job is transmitted, a file to be processed is transmitted.

The file storage unit 15 stores therein a file to be processed by a print job. The destination information storage unit 16, the conversion rule information storage unit 17, and the correspondence information storage unit 18 will be described together with description of operation thereof.

The constituent elements 11 through 14 of the information processing apparatus 10 are realized by cooperative operation between a computer that serves as the information processing apparatus 10 and programs operating on the CPU 1 mounted in the computer. The storage units 15 through 18 are realized by the HDD 4 mounted in the information processing apparatus 10. Alternatively, the storage units 15 through 18 may be realized by the RAM 3 or may be realized by an external memory that is used over a network.

The programs used in the present exemplary embodiment may be provided by a communication unit or may be provided by being stored in a computer-readable recording medium such as a CD-ROM or a USB memory. The programs provided from the communication unit or the recording medium are installed into the computer, and the CPU of the computer sequentially executes the programs. In this way, various kinds of processing are realized.

Next, operation according to the present exemplary embodiment is described. Note that information described below needs to be set in advance for execution of characteristic processing of the present exemplary embodiment.

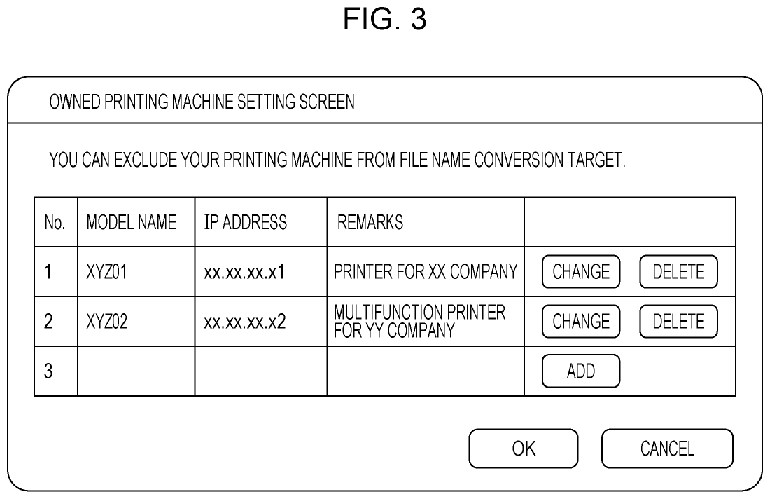

FIG. 3 illustrates an example of an owned printing machine setting screen according to the present exemplary embodiment. A user (an employee belonging to any of the companies or a self-employed person) sets and registers a printing machine which the user personally owns on the owned printing machine setting screen. Specifically, the user sets a correspondence between a model name and an IP address of the printing machine and remarks in which text information or the like for specifying the printing machine can be set. The “printing machine” as used herein is a generic name of an apparatus having a print function, and examples thereof include image forming apparatuses such as a multi-function printer and a printer. Settings made on the owned printing machine setting screen illustrated in FIG. 3 are stored in the destination information storage unit 16 as destination information. In the destination information storage unit 16 according to the present exemplary embodiment, information for specifying a printing machine personally own by a user, in other words, an apparatus that is not a shared apparatus is registered.

It is assumed here that a user can change, delete, access (e.g., refer to), or manage only information set by the user himself or herself. This keeps security among users. Note that this is not a characteristic matter of the present exemplary embodiment, and therefore detailed description thereof is omitted. The same applies to conversion rule information and correspondence information described below. These pieces of information may be generated for each user so that information of each user cannot be accessed by other users.

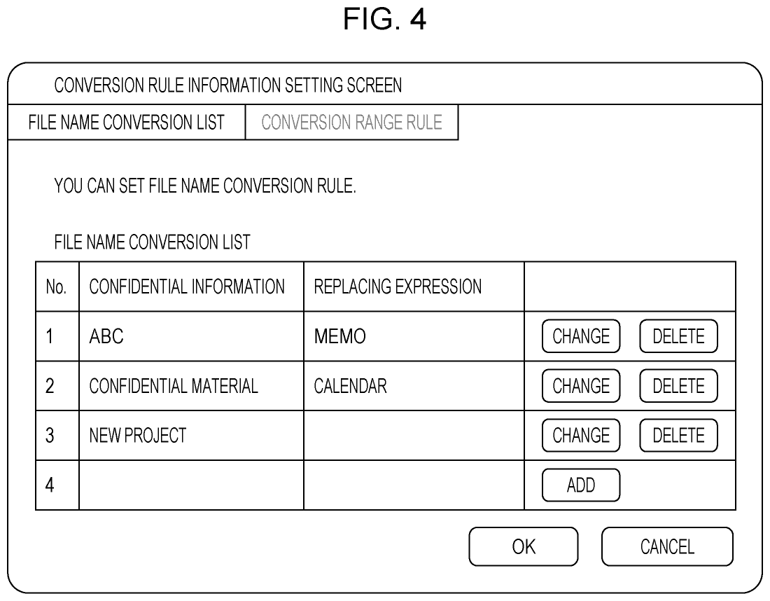

FIG. 4 illustrates an example of a conversion rule information setting screen according to the present exemplary embodiment. Specifically, FIG. 4 illustrates an example of a screen for setting and registering a file name conversion list included in conversion rule information. A user registers a correspondence between confidential information to be converted and a replacing expression that replaces the confidential information on the conversion rule information setting screen illustrated in FIG. 4. In the present exemplary embodiment, the “confidential information” refers to not only information expressed by an expression that is confidential for a user, but also information expressed by an expression from which it is estimated that confidential information is included in a file. The “replacing expression” is an expression that replaces confidential information included in a file name. In the present exemplary embodiment, the replacing expression is for hiding confidential information included in a file name, and therefore the replacing expression itself should not be confidential information. Note that the “expression” refers to a word or a phrase and is expressed by a character string. In the present exemplary embodiment, in a case where a destination of a print job is a shared apparatus and where a file name of a file to be processed by the print job includes confidential information, the job is transmitted to the shared apparatus after converting the confidential information into a different character string. In this case, a user sets, as the different character string, a replacing expression that replaces the confidential information on the conversion rule information setting screen illustrated in FIG. 4. A pair of confidential information and a replacing expression set on the conversion rule information setting screen illustrated in FIG. 4 is stored in the conversion rule information storage unit 17 as part of the conversion rule information.

Note, however, that a user need not necessarily set a replacing expression. That is, a user may set no replacing expression (see the example of confidential information “NEW PROJECT” in FIG. 4). The case where no replacing expression is set will be described later.

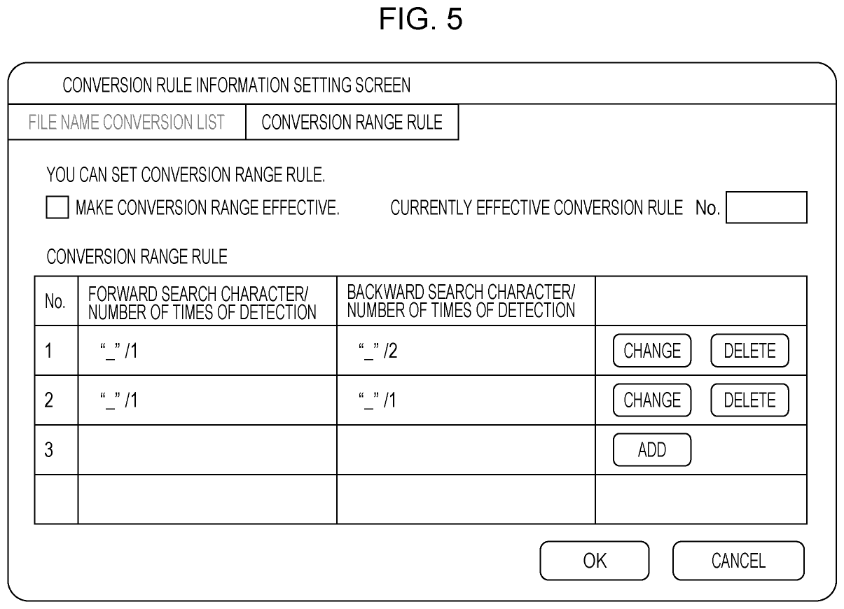

FIG. 5 illustrates an example of a conversion rule information setting screen according to the present exemplary embodiment. Specifically, FIG. 5 illustrates an example of a screen for setting and registering a conversion range rule included in the conversion rule information. A user sets a conversion range rule on the conversion rule information setting screen illustrated in FIG. 5. This conversion range rule will be described together with file name conversion processing using the conversion range rule. A pair of information set on the conversion rule information setting screen illustrated in FIG. 5 is stored in the conversion rule information storage unit 17 as part of the conversion rule information.

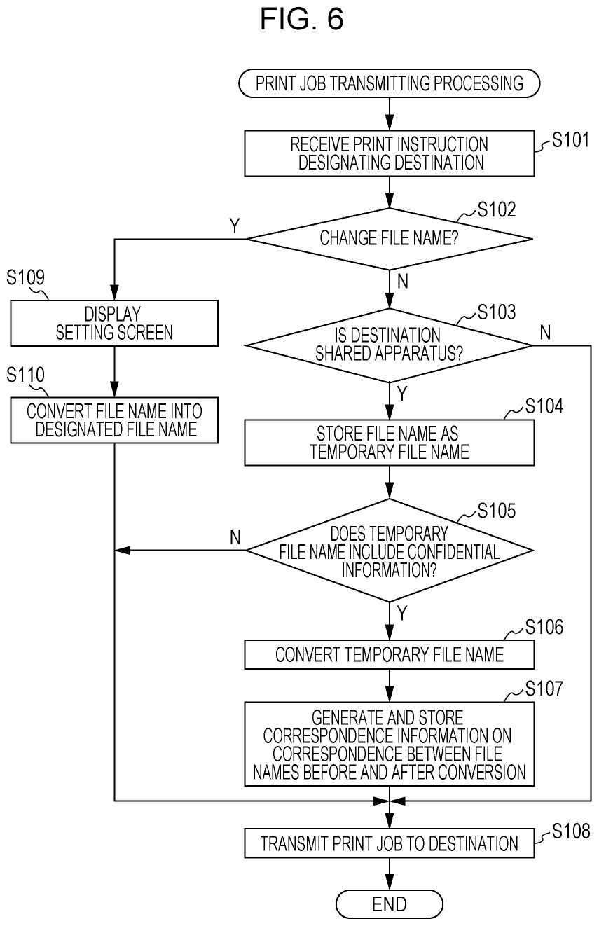

As described above, information used for file name conversion is set and registered in advance on the screens illustrated in FIGS. 3 through 5. This file name conversion is executed when the information processing apparatus 10 transmits a print job. Print job transmitting processing according to the present exemplary embodiment is described below with reference to the flowchart illustrated in FIG. 6.

For example, in a case where a user wants to print a file, the user gives an instruction to execute printing by designating the file to be printed and a printing machine used for the printing, i.e., a destination of a print job. When the print instruction receiving unit 11 receives a print instruction (step 101), the file name deciding unit 12 inquires the user about whether or not to change a file name of the file to be printed. For example, an inquiry screen (not illustrated) is displayed. In a case where the user decides not to designate a file name by himself or herself (N in step 102), the file name deciding unit 12 determines whether or not the destination of the print job is a shared apparatus by referring to the destination information registered in the destination information storage unit 16 and decides whether or not to convert confidential information in accordance with a result of the determination.

In a case where the destination is set in the destination information (N in step 103), the file name deciding unit 12 determines that the destination is a personal printing machine and does not convert confidential information. That is, the file name deciding unit 12 does not change the file name of the file. Accordingly, the job transmitting unit 13 transmits the print job to the destination without changing the current file name (step 108).

The printing machine designated as the destination receives the print job. After executing the print job, the printing machine accumulates therein a job execution history as job log information.

Since the job log information includes the file name of the file to be processed, the user can check the file name by causing the job log information to be displayed, for example, on a panel of the printing machine. In a case where the destination is a personal printing machine and is not a shared apparatus, only a user who owns the printing machine can operate the printing machine, and a third party (e.g., in a case of a shared workspace, other users present in the shared workspace) is supposed to be unable to operate the printing machine. That is, the third party cannot see contents of the job log information. This indicates that confidential information does not leak even in a case where the confidential information is still included in the file name.

Meanwhile, in a case where the destination is not set in the destination information (Y in step 103), the file name deciding unit 12 determines that the destination is a shared apparatus and converts confidential information, that is, converts the file name. For this purpose, the file name converter 122 causes the file name of the file to be printed to be stored as a temporary file name, for example, in the RAM 3 (step 104).

The file name converter 122 checks whether or not the temporary file name includes confidential information by referring to the file name conversion list included in the conversion rule information storage unit 17. In a case where the temporary file name includes confidential information (Y in step 105), the file name converter 122 converts the confidential information included in the file name by replacing the confidential information with a corresponding replacing expression if there is a replacing expression corresponding to the confidential information (step 106). In the setting example illustrated in FIG. 4, in a case where the confidential information is “CONFIDENTIAL MATERIAL”, the file name converter 122 converts the file name by replacing “CONFIDENTIAL MATERIAL” with a character string “CALENDAR”. In a case where there is no replacing expression corresponding to the confidential information, the file name converter 122 specifies an expression that replaces the confidential information by referring to a database such as a dictionary (not illustrated) and replaces the confidential information with the specified expression. A conversion rule that stipulates with which expression confidential information is replaced will be described later in detail.

Although it is assumed in the present exemplary embodiment that a file name includes a single piece of confidential information, a file name may include plural pieces of confidential information. In this case, the file name needs to be converted into a file name that includes no confidential information by replacing each of the pieces of confidential information into a different character string.

After converting the file name as described above, the file name converter 122 generates correspondence information on a correspondence between the file name before the conversion (i.e., the file name stored in the file storage unit 15) and the file name after the conversion (i.e., the converted file name of the temporary file) and causes the correspondence information to be stored in the correspondence information storage unit 18 (step 107).

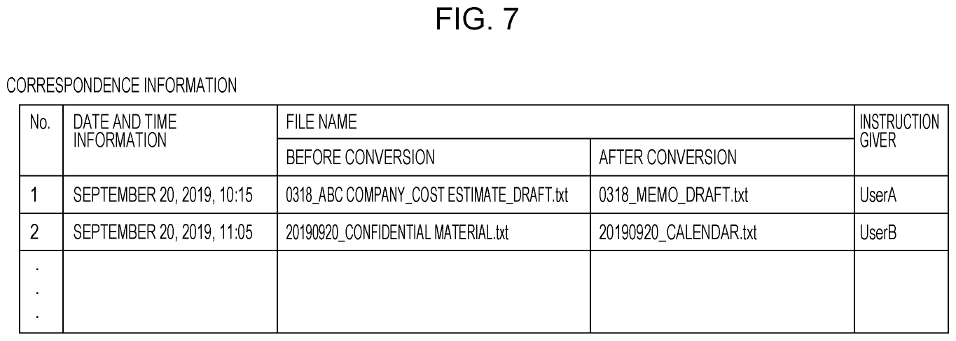

FIG. 7 illustrates an example of a data configuration of correspondence information stored in the correspondence information storage unit 18 according to the present exemplary embodiment. In the correspondence information, date and time information, file names before and after conversion, and an instruction giver are registered in association with an identification number “No.” of the correspondence information. The date and time information is information indicative of a date and a time of receipt of a print instruction. Alternatively, information on a date and time of transmission of a job by the job transmitting unit 13 may be set by the job transmitting unit 13. The instruction giver is identification information of a user who has given a print instruction.

Next, the job transmitting unit 13 transmits the print job to the destination (step 108). In this step, the file is transmitted with the file name obtained after the conversion by the file name converter 122.

Meanwhile, in a case where the temporary file name includes no confidential information (N in step 105), the file name deciding unit 12 determines that there is no need to change the file name. That is, the file name of the file to be printed is not changed. Then, the job transmitting unit 13 transmits the print job to the destination without changing the current file name (step 108).

As described above, in the present exemplary embodiment, in a case where a destination of a print job is a shared apparatus and a file name includes confidential information, the job is transmitted to the destination after changing the file name by replacing the confidential information with a different character string that is not confidential information. For example, in a case where the destination is a shared apparatus, a file name of a file to be processed includes no confidential information. Even in a case where a history of execution of a job is accumulated in job log information of the shared apparatus, it is therefore possible to prevent leakage of confidential information to a third party who refers to the job log information.

In a case where the file name converter 122 automatically converts a file name, a correspondence between file names before and after the conversion may be unknown to a user who is a job sender. In view of this, in the present exemplary embodiment, correspondence information is stored in the correspondence information storage unit 18. The correspondence information presenting unit 14 presents correspondence information in accordance with an instruction from a user. The correspondence information may be presented on the display of the information processing apparatus 10, may be sent to a designated destination (e.g., an e-mail address), may be printed, or may be stored in another file.

In the present exemplary embodiment, correspondence information is stored in association with an instruction giver. Accordingly, only correspondence information related to a user to which correspondence information is to be presented, that is, a user who is a job sender may be extracted from the correspondence information storage unit 18 and be presented to the user.

As described above, in a case where a destination is a shared apparatus and a file name to be processed by a print job includes confidential information, the confidential information is converted into a different character string. This makes it possible to prevent leakage of the confidential information. In the present exemplary embodiment, replacing confidential information with a different character string is synonymous with converting confidential information into a different character string. As a result of conversion of confidential information, a file name is also converted. It can therefore be interpreted that conversion of confidential information is synonymous with conversion of a file name. Furthermore, since a file name of a file transmitted to a destination is changed as a result of conversion of confidential information, conversion of a file name is synonymous with change of a file name.

Although a case where the file name converter 122 automatically converts a file name including confidential information into a file name including no confidential information has been described above, a file name including no confidential information may be designated by a user. Specifically, in a case where a user decides to designate a file name by himself or herself (Y in step 102), the user setting processing unit 121 of the file name deciding unit 12 causes a file name setting screen to be displayed (step 109).

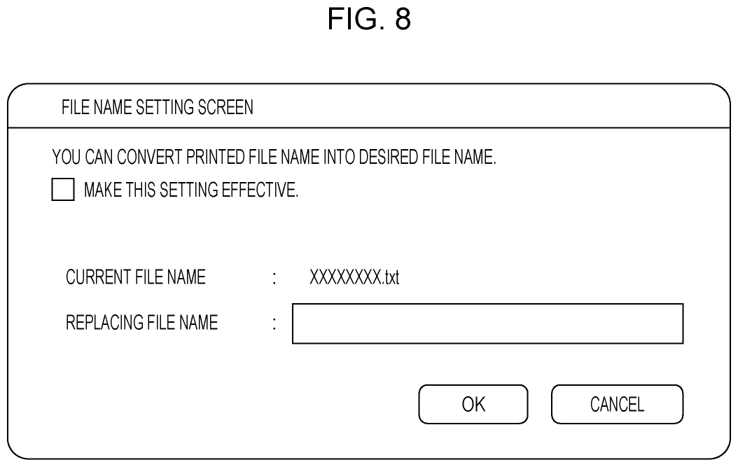

FIG. 8 illustrates an example of the file name setting screen according to the present exemplary embodiment. A user enters a replacing file name on the setting screen. When the user selects an OK button, the user setting processing unit 121 receives the file name entered by the user and converts a file name of a file to be printed into the file name entered and designated by the user (step 110). When the job transmitting unit 13 transmits a print job to a destination (step 108), the file is transmitted with the file name obtained by the conversion by the user setting processing unit 121.

Although a user designates a whole file name on the file name setting screen in the present exemplary embodiment, a user may designate only a character string that replaces confidential information so that the confidential information is converted into the designated character string. In either case, confidential information is converted into a character string designated by a job sender. The user who has designated a file name by himself or herself knows a correspondence between file names before and after conversion. Accordingly, in the present exemplary embodiment, in a case where a user designates a file name on the file name setting screen, generation (step 107) of correspondence information on a correspondence between file names before and after conversion is not executed. Note, however, that correspondence information on a correspondence between file names before and after conversion may be generated.

A confidential information conversion rule is described below.

As described above, in the present exemplary embodiment, leakage of confidential information included in a file name is prevented by converting the confidential information into a different character string. Furthermore, estimation from a character string that confidential information is included in a file is prevented. If it is estimated from a file name that confidential information is included in a file, a result of execution of a print job, that is, a printed material ejected to an output tray may be undesirably stolen by a third party. For example, in a case where confidential information is a proper noun such as a name of a company, a third part may recognize that a file is related to a competitor company and maliciously get a printed material. In this way, there occurs a risk of leakage of confidential information.

In a case where a file includes a proper noun, the file name converter 122 may determines that the proper noun is confidential information and automatically convert the proper noun into a different character string even if the proper noun is not set in the file name conversion list.

It is not always possible to avoid unexpected information leakage just by converting confidential information included in a file name into a different character string. For example, if confidential information is replaced with date and time information although a file name includes date and time information, the replacement results in that the file name includes two pieces of date and time information. This is unnatural. Furthermore, if a processed file has the same file name as a file name of a file processed by a latest job, a third party may regard this as unnatural. Such unnaturalness may give a hint that allows a third party to estimate that a file name has been changed. In view of this, an unnatural file name can be regarded as being unable to hide confidential information.

As described above, examples of an unnatural file name include a file name including similar pieces of information (e.g., a file name including plural dates, plural documents types, or plural company names) and a file name that does not make sense (e.g., “20190830 corporation”, which is a combination of a date and a company name). Furthermore, it can be regarded as unnatural if job log information has plural records of the same file name within a predetermined period.

In view of this, when automatically deciding an expression that replaces confidential information, the file name converter 122 selects an appropriate word from a dictionary, for example, by referring to other character strings included in a current file name and file names stored in job log information of a destination (especially file names recorded in a predetermined latest period).

For example, it is unnatural that a file name includes expressions that belong to the same category (e.g., a date or a document type). In view of this, when selecting an expression that replaces confidential information included in a file name, for example, from a dictionary, the file name converter 122 selects an expression that belongs to a category different from an expression expressed by a character string included in the file name that is not confidential information and is therefore not replaced. Furthermore, the file name converter 122 selects a character string that replaces confidential information so that the file name is not converted into the same file name as previously-printed files by referring to file names included in job log information stored in a shared apparatus. In particular, the file name converter 122 converts confidential information so that the file name is converted into a file name different from a file of a job transmitted within a period (e.g., within the last one week) set in advance by a job sender.

Although a confidential information conversion rule used by the file name converter 122 has been described above, it is also desirable that a user who sets a replacing expression in the file name conversion list in the conversion rule information sets the replacing expression in accordance with the confidential information conversion rule described above so that a file name is not converted into an unnatural file name.

Although an example in which confidential information is converted in accordance with the file name conversion list set in the conversion rule information storage unit 17 has been described above, the following describes processing for converting a file name by also referring to a conversion rule prepared separately from the file name conversion list.

First, it is assumed that ““_”/1” is set in the field “forward search character/number of times of detection” as illustrated in FIG. 5. This means that a forward search character is “_” and that the number of times of detection of the forward search character is 1. Similarly, it is assumed that ““_”/2” is set in the field “backward search character/number of times of detection”. This means that a backward search character is “_” and that the number of times of detection of the backward search character is 2. Furthermore, it is assumed that in the file name conversion list, confidential information “ABC” is set in association with a replacing expression “MEMO” as illustrated in FIG. 4.

The information processing apparatus 10 executes processing in accordance with the flowchart illustrated in FIG. 6. It is assumed here that a file name of a file to be printed is “0318_ABC COMPANY_COST ESTIMATE_DRAFT.txt”.

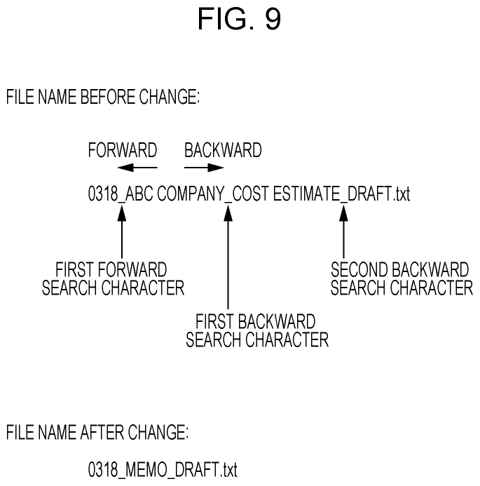

In this example, a temporary file name includes the confidential information “ABC” (Y in step 105), and therefore the file name deciding unit 12 converts the temporary file name (step 106). In this case, the file name converter 122 decides a file name of the file to be printed as follows by referring to the conversion rule information. This decision of the file name is described below with reference to FIG. 9.

First, a character string located before the confidential information “ABC”, more specifically, a character string located before the initial character “A” of “ABC” is searched to detect the forward search character “_” in accordance with the settings of the conversion range rule. In a case where the forward search character “_” is detected, a character string that follows this forward search character “_” is set as a target to be converted. Note that the character “A” that immediately follows the forward search character “_” serves as a start point of a conversion range.

Next, characters that are located after the confidential information “ABC”, more specifically, a string of characters that are located after the final character “C” of “ABC” are searched to detect the backward search character “_” in accordance with the settings of the conversion range rule. In a case where the backward search character “_” is detected twice, a character “E” that immediately follows the second backward search character “_” serves as an end of the conversion range.

The file name is converted by replacing the character string “ABC COMPANY_COST ESTIMATE” in the conversion range decided as described above with the replacing expression “MEMO”.

In the file name conversion using the conversion range rule, in a case where a forward search character is not detected in a temporary file name a set number of times, an initial character of a character string located before the confidential information “ABC” may be, for example, used as a start point of a conversion range. Similarly, a final character of a character string located after the confidential information “ABC” may be used as an end point of the conversion range. In this way, even in a case where a file name cannot be converted in accordance with a conversion range rule, the file name is converted as appropriate so that confidential information does not leak.

In the present exemplary embodiment, a user registers information on a printing machine personally used by the user in the destination information storage unit 16. Conversely, information on a shared apparatus may be registered. Actually, information on a shared apparatus may be registered. However, it is not always the case that a user knows all shared apparatuses. If there is a shared apparatus that has not been registered, this shared apparatus is erroneously recognized as a personal printing machine. Accordingly, processing is performed without conversion of a file name including confidential information, and the file name including the confidential information is recorded in job log information of the shared apparatus. Since the shared apparatus can be operated by anyone in a shared workspace, the confidential information leaks to a third party, for example, if the job log information is displayed on a panel.

To avoid such a situation, the present exemplary embodiment employs a configuration in which a user sets and registers, in the destination information storage unit 16, information on an apparatus that is not a shared apparatus, that is, information on a printing machine personally used by the user, as described above. With this configuration, in a case where a destination of a job is not registered in the destination information storage unit 16, the file name deciding unit 12 determines that the destination is a shared apparatus. Even if a user fails to register information on a printing machine personally used by the user, this printing machine is erroneously recognized as a shared apparatus, and therefore confidential information included in a file name is converted. Although a file name that need not be converted is converted, it is possible to prevent leakage of confidential information included in a file name with certainty.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to, in a case where a destination of a job is a shared apparatus shared by a plurality of groups and a file name of a file to be processed by the job includes confidential information, transmit the job to the shared apparatus after converting the confidential information into a different character string.

2. The information processing apparatus according to claim 1, wherein
the confidential information is a proper noun.

3. The information processing apparatus according to claim 1, wherein
the different character string is an expression that belongs to a category different from a category to which an expression used in the file name belongs.

4. The information processing apparatus according to claim 2, wherein
the different character string is an expression that belongs to a category different from a category to which an expression used in the file name belongs.

5. The information processing apparatus according to claim 1, wherein
the different character string is decided while referring to a file name included in job log information stored in the shared apparatus to which the job is to be transmitted.

6. The information processing apparatus according to claim 2, wherein
the different character string is decided while referring to a file name included in job log information stored in the shared apparatus to which the job is to be transmitted.

7. The information processing apparatus according to claim 5, wherein
the confidential information is converted so that the file name becomes different from a file name of a file of a job transmitted within a period set in advance by a sender of the job.

8. The information processing apparatus according to claim 6, wherein
the confidential information is converted so that the file name becomes different from a file name of a file of a job transmitted within a period set in advance by a sender of the job.

9. The information processing apparatus according to claim 1, wherein the processor is configured to:
determine whether or not the destination of the job is the shared apparatus by referring to destination information for determining whether or not the destination of the job is the shared apparatus and decide whether or not to convert the confidential information in accordance with a result of the determination as to whether or not the destination of the job is the shared apparatus.

10. The information processing apparatus according to claim 9, wherein
the destination information includes information for specifying an apparatus that is not the shared apparatus; and
the processor is configured to:
determine that an apparatus that is not specified as an apparatus that is not the shared apparatus is the shared apparatus.

11. The information processing apparatus according to claim 1, wherein
the confidential information is converted into a character string designated by a sender of the job in a case where the destination of the job is the shared apparatus.

12. The information processing apparatus according to claim 1, wherein the processor is configured to:
generate correspondence information on a correspondence between file names before and after conversion.

13. The information processing apparatus according to claim 12, wherein the processor is configured to:
present the correspondence information to the sender of the job.

14. A non-transitory computer readable medium storing a program causing a computer to execute a process for information processing,
the process comprising, in a case where a destination of a job is a shared apparatus shared by a plurality of groups and a file name of a file to be processed by the job includes confidential information, transmitting the job to the shared apparatus after converting the confidential information into a different character string.

15. An information processing apparatus comprising
transmitting means for transmitting, in a case where a destination of a job is a shared apparatus shared by a plurality of groups and a file name of a file to be processed by the job includes confidential information, the job to the shared apparatus after converting the confidential information into a different character string.
